(19) United States
(12) Patent Application Publication
(10) Pub. No.: US 2010/0276829 A1
(43) Pub. Date: Nov. 4, 2010

(54) High Aspect Ratio Microstructures and Method for Fabricating High Aspect Ratio Microstructures From Powder Composites

(76) Inventors: Guohua Yang, Woodland, CA (US); Olga Makarova, Naperville, IL (US); Platte Amstutz, III, Vienna, VA (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/223,863

(22) PCT Filed: Feb. 12, 2007
(86) PCT No.: PCT/US2007/003821

§ 371 Date: Jul. 19, 2010

Related U.S. Application Data
(60) Provisional application No. 60/772,583, filed on Feb. 13, 2006.

(51) Int. Cl. B29C 41/50; B22F 3/24; B29C 41/04; B29C 41/46

(52) U.S. Cl. 264/101; 264/122; 264/114

(57) ABSTRACT

Methods to fabricate high aspect ratio powder composite microstructures is provided by filling a molding composition containing a powdered material and a binder into a patterned mold, and releasing the cured composite microstructures from the mold. An alternate method is by filling a mix of powdered dense metals and low-melt alloys into a patterned mold, and releasing the melted and solidified composite microstructures from the mold. The mold is derived from lithographically defined parent mold. One example of the application is in the field of x-ray anti-scatter grids and nuclear collimators.

This application claims benefit under 35 U.S.C. §119 from U.S. Provisional Application No. 60/772,583, filed on Feb. 13, 2006, the entire content of which is incorporated herein by reference.

### FIELD OF THE INVENTION

The present invention relates to high aspect ratio microstructures, a process and various methods for realizing the process of fabricating high aspect ratio microstructures from a molding composition by filling a mold or its derivative polymeric mold. This invention is applicable to the fabrication of x-ray anti-scatter grids, nuclear collimators, and other high aspect ratio structures using high-density powdered materials in combination with a polymeric or low melting temperature metal or other material. It is also applicable to the fabrication of optical components, such as optical collimators and other structures, using high and/or low-density metal, ceramic, and/or polymeric materials. The fabrication methods do not require the use of high pressure or high temperature sintering.

### BACKGROUND OF THE INVENTION

X-ray anti-scatter grids, that may be used to eliminate scatter in x-ray imaging, and nuclear collimators, that may be used to collimate gamma-rays for nuclear imaging, require thin septa made of high density materials, tall septa to provide the desired resolution and absorption of high energy x-ray and gamma-rays. They are likely to be of large area from a few centimeters square to more than one thousand centimeters square, and may require the septa to be oriented to a focal spot or focal line. Exemplary embodiments of the present invention provide for the fabrication of such grids and collimators. However, there are many other high aspect ratio microstructures that can be fabricated using the methods according to exemplary embodiments of the present invention, such as integrated circuit interconnects, optical collimators and other components, and microfluidic devices.

Related published patent applications and patents are briefly summarized below.

Injection molding or compression molding using thermoplastic loaded with metal powder is described in U.S. Pat. No. 6,470,072 issued on Oct. 22, 2002, the entire content of which is incorporated herein by reference. Injection molding described in this patent requires high pressure and does not provide for use of metal powder mixtures to make composite metal grids and collimators.

A series of related patent applications using metallic foil stack lamination parent mold including U.S. Pat. No. 7,141,812 issued Nov. 28, 2006, U.S. Patent Publication No. 2003/0128812 published on Jul. 10, 2003, U.S. Patent Publication No. 2003/0128813 published on Jul. 10, 2003, and U.S. Patent Publication No. 2004/0156478 published on Aug. 12, 2004 are incorporated herein by reference in their entirety. These applications describe the fabrication of metal powder composite microstructures, including grids and collimators, by the following methods: (1) molds pre-loaded with dense powder, followed by alloy or polymer, and (2) polymer or alloy pre-loaded with dense powder injected into the mold. These applications appear to rely on non-proprietary standard methods for fabrication of the molded parts themselves, while the metallic foil stack lamination is used solely to produce the parent mold.

Fabrication of high aspect ratio, micron or submicron ceramic parts using lithographic methods are described in U.S. Pat. No. 6,245,849, issued Jun. 12, 2001, the entire content of which is incorporated herein by reference. The mold is either PMMA or SU-8. High pressure 1000 lb/in² to 5000 lb/in² is used to press the ceramic composite into the mold. A similar process to fabricate metal powder parts is described in U.S. Patent Publication No. 2001/0038803, published on Nov. 8, 2001, the entire disclosure of which is incorporated herein by reference. High pressure 5000 lb/in² to 35,000 lb/in² is used to press the metal composite into the mold. In order to release the ceramic or metal part from the SU-8 or PMMA mold, the mold itself must be destroyed.

Another conventional method uses high density particulate/binder composites to fabricate grids and collimators as described in U.S. Patent Publication No. 2005/0281701, published on Dec. 22, 2005, the entire contents of which are incorporated herein by reference. Two methods were used to fill the mold: (1) metal powder is placed into the mold, and polymeric resin is introduced into the mold by vibration compaction under vacuum, and (2) a mixed metal/resin paste is placed on top of the mold, and vibration is used to force the paste into the mold under vacuum.

U.S. Pat. No. 5,949,850 issued on Sep. 7, 1999, U.S. Pat. No. 6,252,938 issued Jun. 26, 2001, U.S. Pat. No. 6,252,938, issued Jan. 4, 2005, U.S. Pat. No. 6,987,836, issued on Jan. 17, 2006, and U.S. application Ser. No. 11/188,210 filed on Jul. 25, 2005, the entire content of all of which is incorporated herein by reference describe methods to use ultraviolet grid x-ray lithography, followed by electroforming, to make x-ray grids and collimators. Grids and collimators made by these methods can be used as mold inserts, or parent molds, of the molds for the molding applications.

Powder composites have been used in many injection molded products for many years for macroscopic structures or low aspect ratio structures. The molds are usually deformable under high pressure, and a mold-releasing agent has to be applied prior to the molding step. Such injection molding methods are not suitable for fabrication of microstructures, because the deformable molds and conventional mold-releasing agents cause unacceptable deformities in the microstructures. Despite the conventional technologies described above, structures such as grids and collimators with aspect ratio larger than about 5 and an area larger than a few centimeters square have not yet been produced with microscopic precision and with consistent density. One of the reasons for the failure of these methods to produce undistorted structures with consistent density is the difficulty to make the highly viscous composite mix materials fill the narrow trenches of the mold without gaps, voids, or air bubbles. The use of high pressure, such as that used in injection molding machines, easily distorts the flexible molds, resulting in distorted product.

### SUMMARY OF THE INVENTION

Accordingly, it is an object of exemplary embodiments of the present invention to use a lithographically defined parent mold and its derivative mold for making large area, high-density composite microstructures with high aspect ratio and high precision.

It is another object of exemplary embodiments of the present invention to provide a method that involves filling a molding composition containing a powdered material and a binder into a patterned mold, and releasing the cured composite microstructures from the mold.

It is still another object of exemplary embodiments of the present invention to provide a method that involves filling a mix of powdered dense metals and low-melt alloys into a patterned mold, and releasing the melted and solidified composite microstructures from the mold.

According to exemplary embodiments of the present invention, a fabrication process for forming a high aspect ratio composite microstructure comprises providing a lithographic defined parent mold and its derivative mold having a plurality of elevated patterns defining openings therein filling the mold with a molding composition containing a powdered material and a binder hardening the binder to form a composite microstructure product in the mold and releasing the composite product from the mold.

According to another exemplary embodiment of the present invention, a fabrication process for forming a high aspect ratio composite microstructure comprises providing a lithographic defined parent mold and its derivative mold having a plurality of elevated patterns defining openings therein, filling the mold with a mixture of powdered metal and low-melt alloys, melting the powdered mixture under vacuum and thereafter allowing it to solidify to form a composite microstructure product in the mold and releasing the composite product from the mold.

Further aspects of certain exemplary embodiments of the present invention will be understood by those of skill in the art upon reviewing the teachings herein. Other aspects of certain exemplary embodiments of the present invention may involve combinations of the above noted aspects of the invention and/or addition of various features of one or more embodiments.

### BRIEF DESCRIPTION OF THE DRAWINGS

FIG. 1. Schematic illustration of the general concept of fabrication of powder composite using mixed powder composite(s) with binder into a mold according to exemplary embodiments of the present invention.

FIG. 2. Schematic illustration of four different filling methods: (a) vacuum casting, (b) pressure casting, (c) centrifugal casting and (d) infiltration according to exemplary embodiments of the present invention.

FIG. 3. Schematic illustration of vacuum casting of metal powders, followed by melting and solidifying according to exemplary embodiments of the present invention.

FIG. 4. Scanning electron microscope image of the fabricated tungsten/epoxy composite grid according to an exemplary embodiment of the present invention.

FIG. 5. Photograph of the fabricated tungsten/low-melt alloy composite collimator according to an exemplary embodiment of the present invention.

### DETAILED DESCRIPTION OF EXEMPLARY EMBODIMENTS

The term “composite” is conventionally understood to refer to engineering materials made from two or more constituent materials that remain separate and distinct on a macroscopic or microscopic level, while forming a single component. Thus, the term “composite” as used herein describes powdered materials surrounded by a polymeric, ceramic, and/or metallic matrix.

As used herein, the term “mold” refers to a structure that is used as a tool to create a replicate part or product that has substantially the same size and shape as an original model part or parent mold.

As used herein, the terms “mold insert” and “parent mold” refer to the structure that is the model part, the size and shape of which is to be replicated in the fabrication process.

As used herein, the term “composite product” refers to a composite structure that has been produced by the methods of the present invention.

The “aspect ratio” of a structure is the ratio of the height to the width of the structure. Aspect ratio is high when this ratio is greater than two-to-one (2:1) or three-to-one (3:1). Examples of high-aspect-ratio structures are anti-scatter grids for x-ray imaging and collimators for gamma ray imaging.

It is noted that the above definitions are not limiting as to the scope of the present invention, but are set forth herein merely for clarity and completeness.

An exemplary embodiment of the present invention provides a method for making high-aspect-ratio composite products, which involves providing a mold having a plurality of elevated patterns defining openings. The mold is filled with a molding composition containing a powdered material and a binder. After curing and/or hardening the binder to form a composite material in the mold, the composite product is released from the mold, yielding a composite product of a shape that conforms to the cavities in the mold. Depending on the intended use of the composite product, it may be removed from the mold or allowed to remain in the mold. For example, the composite product is lapped and polished to provide a planarized surface.

The parent mold according to exemplary implementations of the present invention is, for example, a lithographically patterned mold, prepared using x-ray or ultra-violet (UV) lithography with ultra-thick photoresist. Suitable photoresists may comprise, for example, positive polymethylmethacrylate (PMMA) or negative SU-8. The resist, deposited on a conductive substrate, typically a graphite surface, is irradiated using x-ray or UV radiation with a mask to provide the desired pattern. Following exposure, the resist is developed using a suitable solvent to remove the irradiated areas of a positive photoresist or the unexposed areas of a negative photoresist. The resulting elevated patterns, which have a width of less than 5 microns to greater than 1000 microns and a height of less than 100 microns to greater than 5000 microns, can be used as a parent mold.

In an exemplary implementation the lithographically patterned mold can be electroplated with metals, typically copper or nickel, to provide a metal structure as the parent mold. The lithographically patterned mold and the metal parent mold can be use to make replicate molds using conventional replication techniques, such as injection molding, hot embossing, and vacuum casting. However, metal parent mold may be used due to very high aspect ratio, pattern precisions, and smooth wall surface thereof to facilitate the mold releasing properties. Thus, according to an exemplary implementation, the aspect ratio of the composite products fabricated herein, can be typically 16:1 or even 32:1 or higher.

Certain exemplary embodiments of the present invention have been developed in order to enable the production of high aspect ratio structures from a wide range of molding materials suitable for specific applications. The various materials that can be used to make derived molds include, but are not limited to, acrylics and other plastics, silicone rubber, thermo-set plastic, wax, ceramic, metals, metal alloys, and combinations thereof. It is possible to have many material options for each specific application.

Exemplary embodiments of the present invention have been developed to make mold replicates, thus enabling the fabrication of high-aspect-ratio structures. Among various materials tested, RTV silicone rubbers have been successfully used to create molds that are very close replicates of the lithographically patterned mold and the metal parent mold. Molds made from RTV silicone rubbers are fabricated by embedding a lithographically patterned mold or the metal parent mold with a commercial silicone rubber (for example, Dow Corning Corporation, Midland, Mich.) and degassing the silicone to remove entrapped air bubbles. After curing of the silicone, which lasts up to 24 hours depending on the curing temperature and on the particular silicone used, the lithographically patterned mold or the metal parent mold can be removed from the silicone rubber mold.

The elasticity of the silicone rubber molds simplifies the releasing process, but it may introduce distortion during the subsequent process of filling the mold with composite material. For production of very high aspect ratio structures, more rigid molds may be needed. Polymeric molds of polyurethane, epoxy, acrylics have been fabricated for these specific applications.

In an exemplary embodiment of the present invention, the surface of the mold may be coated with a low adhesion layer to facilitate the releasing process and to improve wetting properties of the molding composition. Suitable surface treatment include, but are not limited to a thin surface coating of “Teflon-like” thiols and silanes, silicones, waxes or the like. Such thin coating layers may be applied by vapor deposition and spraying.

In another embodiment, the outer surface of the mold can be shaped to facilitate entry of the molding composition material, for example with a rounded or angled shape.

After the mold is prepared, a molding composition is prepared comprising a binder and a powdered material. The binder serves two purposes. First, it is used to retain the powdered material in the desired pattern after molding. The binder also provides lubrication during molding. Polymeric binders useful in the invention include, but are not limited to, thermally/chemically curable polymer resins. The thermally/chemically curable polymer resins include vinyl, acrylic, silicone and silicon based polymers, and epoxy. Other binders that may be used according to certain exemplary implementations of the present invention include, but are not limited to, ceramic materials, such as alumina, titanium dioxide, and similar materials.

In an exemplary embodiment, low-melt metal materials can be also used as a binder. The low-melt materials include lead, bismuth, tin, indium, antimony, cadmium and their mixtures, and waxes including casting wax, injection wax, paraffin or the like.

The powders used in a molding composition can be metallic and ceramic materials according to their applications. For application to anti-scatter grids and nuclear collimators, metallic powders with a high density and high atomic number may be used. Such metallic powders include, but are not limited to, tungsten, gold, tantalum, silver, copper, lead, nickel, and mixtures thereof. For application to optical collimators, powders with high reflectivity may be used, such as aluminum, silver, titanium dioxide and similar.

The powdered materials may be commercially available (for example, Inframat Corporation, Farmington, Conn.; Atlantic Equipment Engineers, Bergenfield, N.J.). These powders have a size of approximately 0.1 to approximately 100 microns in diameter, preferably approximately 1 to approximately 5 microns in diameter. The metallic powders generally represent about 50 to about 100% by weight of the molding composition, and in an exemplary implementation may represent about 85 to about 98% by weight of the composition.

Alternatively, suitable molding compositions are commercially available. For example, ECOMASS, a tungsten-thermoplastic mix from M. A. Hannah Engineered Materials of Norcross, Ga., and a Technon tungsten-epoxy mix from Tungsten Heavy Powder, Inc. of San Diego, Calif. can achieve a density 11 grams/cc, equivalent to lead.

Depending on the mold material and the powder to be used in the molding composition, appropriate binders and/or binder systems may be selected to maximize desired composite strength and to minimize the structural shrinkage. When included, the binder will normally represent from about 1 to about 50% by weight of the molding composition, with 3 to about 15% by weight being more typical, whereas the powders typically represent about 85 to about 97% by weight of the molding composition.

The molding composition may include other components in addition to the binders and the powdered materials, such as dispersants, surfactants, plasticizers, or the like. For the preparation of the molding composition, polymeric binder and one or more dispersants are thoroughly mixed with the dried powdered material. Solid contents for standard powders are in the range of about 80 wt % to about 98 wt %. A low viscous molding composition, for example, comprises about 94 wt % tungsten powder with average particle size of 2 microns and about 6 wt % organics. The later consists of low viscosity epoxy and about 0.3 wt % of a suitable dispersing agent. This molding composition has been successfully applied to produce composite parts with a high aspect ratio of 16 and a density of approximately 10 grams/cc.

When low-melt, fusible metals or alloys are used as binders, a fluxing agent is normally thoroughly mixed with metal powders. Suitable fluxing agents will be well known to those skilled in the art. Examples of common fluxing agents such as rosin resin based flux are commercially available.

The selection of a filling method depends on the dimensions, feature size, and material of the mold that is used. In the case that an elastic silicone rubber mold is used, methods with low load and low pressures are preferred. Filling methods that have been successfully used with silicone rubber molds are low-pressure casting, centrifugal casting, and vacuum casting. A common feature of these methods is that they are based on the low pressure loads applied.

In an exemplary embodiment, the silicone molds are filled by low-pressure casting at pressures below 100 psi, which prevents deformity of the silicone mold and the resulting mold product due to the elasticity of the silicone mold. The silicone molds are mounted into a fixture and placed in a pressure chamber connected with an air compressor. By increasing the pressure of the air or other gas, a low viscosity molding composition can be forced into a high aspect ratio silicone mold and achieve a complete filling of the mold.

In an exemplary embodiment, the same molding composition prepared for low-pressure molding can also be used for centrifugal casting. In centrifugal casting the molding composition is driven into the mold by centrifugal forces. The filling of the molds is normally performed at rotational speeds below about 2000 RPM to avoid the deformation of silicone molds. During the centrifugation of the molding composition, densification may be achieved, which may be beneficial to achieve higher density of the molded composite parts. Due to thermal isolation of the mold and short centrifugal times, the silicone mold has the opportunity to reduce tensions and to achieve the correct size.

In an exemplary embodiment, vacuum casting in a vacuum oven has been used to fill the mold with a low viscosity molding composition. The molds may be heated and evacuated during or after casting to remove air bubbles and to facilitate the filling process. The temperature and duration of the heating may be chosen to alter the characteristics of the molding composite, such as viscosity and curing time.

Exemplary embodiments of the present invention include a process for achieving the foregoing aspects of high aspect ratio microstructures and the exemplary high aspect ratio microstructures achieved thereby. Various techniques can be used for filling the molds with the molding composition, including injection molding, vacuum or pressure molding, centrifugal molding, and/or infiltration. The molding composition, after having been filled into the mold and cured/hardened, may then be released from the mold to produce the fabricated free-standing microstructure. Depending on the application, the mold materials may be left with the molded products, and the microstructure may also be left with or without a base.

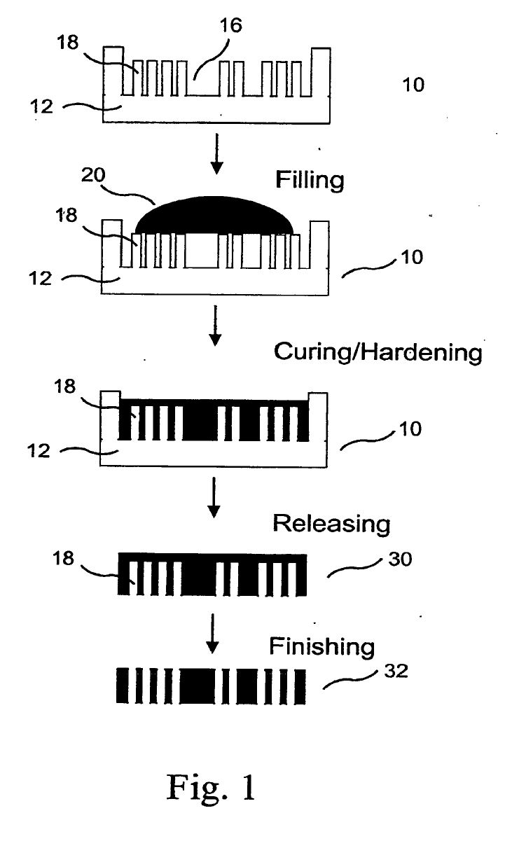

An exemplary implementation of a method according to exemplary embodiments of the present invention is illustrated schematically in FIG. 1, where the patterned mold shown generally at 10; comprises backing 12 and openings 16 between corresponding elevated patterns 18. The mold 10 is filled with a molding composition 20 comprising a powdered material and a binder. After curing and/or hardening the binder to form a composite material in the mold, the composite product 30 with the backing is release from the mold. The final composite product 32 is provided upon lapping and polishing to provide a planarized surface.

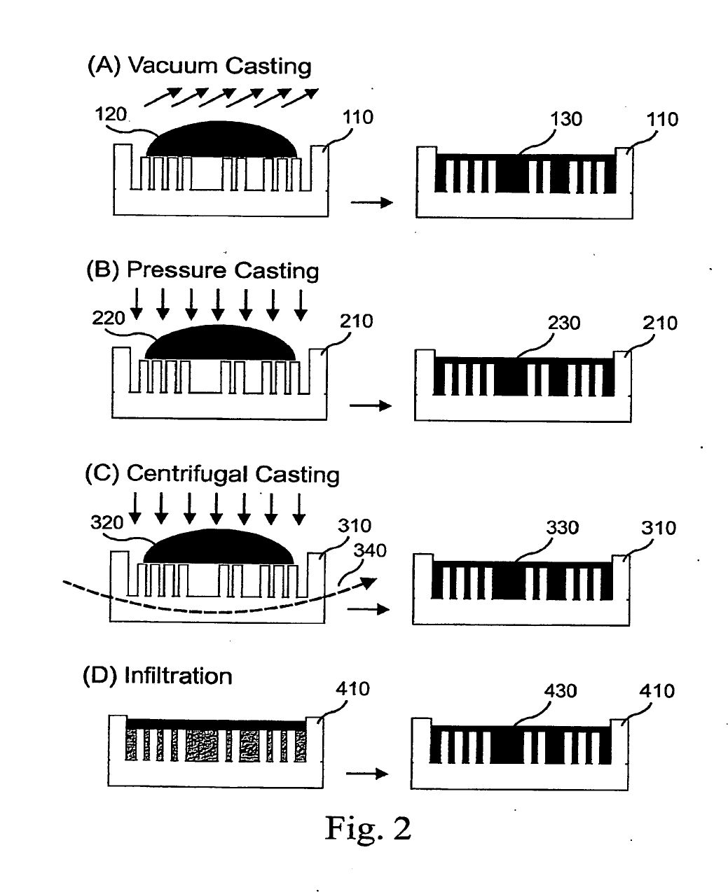

Exemplary embodiments of the present invention further include methods of filling the mold as illustrated schematically in FIG. 2a-2d. The molding composition 120, 220, 320 is first applied onto the mold 110, 210, 310. The molding composition fills the mold either by vacuum casting (shown in FIG. 2a), low pressure casting 340 (shown in FIG. 2b), or centrifugal casing (shown in FIG. 2c). After filling, the molding composition undergoes a hardening step, producing a strong molded product 130, 230, 330, which can be released from the mold by dissolving the mold, or it may be mechanically removed from the mold. In another embodiment, an infiltration of the binder is performed, shown in FIG. 2d. The powder is filled into the mold 410 by pressure or by centrifugation with a fluxing agent such as alcohol and water. The volume fraction is, for example, between 40 and 60 percent. After drying and evacuating, a binder is applied at the top of the mold and is infiltrated into the shaped powder structure 430 by pressure and centrifugal force. After curing/hardening, the mold is removed.

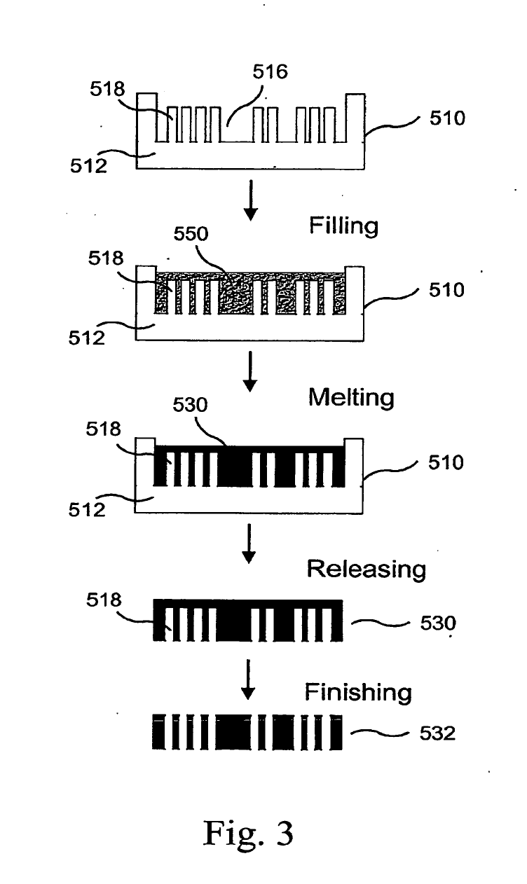

Another exemplary implementation of a method according to exemplary embodiments of the present invention is illustrated schematically in FIG. 3, where the patterned mold is filled with a homogeneous mixture of dense metal powders and low melt, fusible powdered alloys or metals with a fluxing agent. The mixture of powders 550 can be filled into the mold 510 by pressure or by centrifugation with a fluxing agent. The low melt, fusible powders are commercially available (e.g. Indium Corporation, Utica, N.Y.). After drying under vacuum, the mold is gradually heated to above the melting temperature of the low-melt, fusible material in the mold in a vacuum oven for a short period of time and then the mold is cooled down to room temperature with the molding composition. After solidification of the molding composition, the composite product 530 is finally released from the mold. If desired, the composite product may be lapped and polished to provide a planarized surface 532.

In an exemplary embodiment, the dense metal powders can be coated with a metal layer to improving wetting properties. Metal-coated powders, such as Copper-Coated Tungsten and Tin-Coated Tungsten particles, can be obtained from Federal Technology Group of Bozeman, Mont.

In this exemplary implementation, the molding composition can be easily filled into the fine detail of the high aspect ratio mold with a minimal deformation of the mold and an improved uniformity of the composite material.

### Example 1

This exemplary implementation describes fabrication of high aspect ratio tungsten composite grids using epoxy as the binder.

An SU-8 mold on the graphite substrate was prepared by UV lithography of 600 micron thick SU-8 negative photo resists. The SU-8 mold was patterned with a 64×64 array of square cells, surrounded with a 2 mm border. Each cell has a 341 μm×341 μm square opening separated by 39 μm septa walls. After cleaning, the mold was vapor deposited with a coating of perfluorodecanethiol.

An RTV silicone rubber mold was prepared by casting Silastic M RTV silicone resin into the prepared SU-8 parent mold. The resin base and its curing agent (ratio of 10:1 by weight) were thoroughly mixed and poured over the SU-8 parent mold, and degassed in a vacuum chamber to remove entrapped air bubbles. After curing of the silicone for 16 hours at room temperature, the elastic RTV mold was peeled from the SU-8 parent mold.

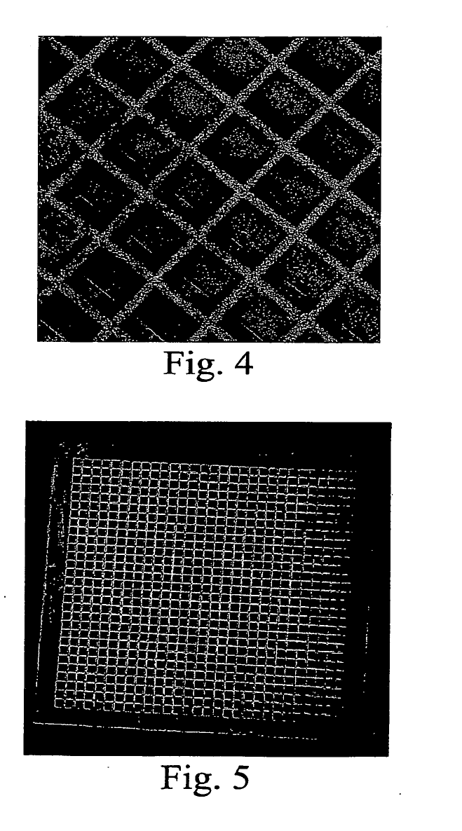

A molding composition was prepared with 9.2 g W powders, 0.77 g epoxy resin, 0.03 g dispersant. Initially, the molding composition was thoroughly mixed and applied into the RTV silicone mold. The mold was then placed in a centrifuge with a swing bucket and rotated at rotational speeds for 2 minutes at 2000 RPM. Subsequently, the mold with the molding composition was allowed to cure at room temperature overnight to reduce shrinkage. The resulting composite part was removed mechanically by peeling off of the RTV mold, and a SEM image of the composite product is shown in FIG. 4. The density of the composite product was 9.5 grams/cc.

### Example 2

This exemplary implementation describes fabrication of high aspect ratio tungsten composite collimators with low-melt, fusible metals as the binder using the alternative method as illustrated in FIG. 3.

A copper lithographic parent mold 510 comprising backing 512 and opening 516 between corresponding elevated patterns 518 was prepared by X-ray lithography. The copper lithographic parent mold is prepared as follows:
(a) Positive photoresist, PMMA, is attached on the graphite substrate.
(b) The x-ray mask is aligned onto the resist/substrate. This mask/resist/substrate assembly is then exposed at an x-ray source to transfer the pattern to the photo resist. The polymer chains are destroyed in the irradiated portions of the resist, rendering them suitable for solvent removal.
(c) The exposed PMMA and substrate is then developed, selectively dissolving the exposed resist while leaving the non-irradiated parts, which remain unchanged.
(d) Copper is electroplated into the resulting resist mold.
(e) The graphite substrate is removed, and the plated resist piece polished on both sides.
(f) The remaining PMMA resist is removed by wet etch.

The copper mold has a 29×29 array of square cells, surrounded by a 2 mm border. Each cell has an 888 μm×888 μm square opening separated by 133 μm septa walls. The mold is 2 mm thick. After cleaning, the mold was vapor deposited with a coating of perfluorodecanethiol to improve the de-molding process.

The preparation of the RTV silicone rubber mold was described in Example 1. About 25 wt % of tungsten powders were mixed with Bi58-Sn42 alloy powders using 10% ethanol as fluxing agent. The mixture 550 was then filled into the RTV mold by centrifugal forces as described in Example 1. The mold was then place in a vacuum oven and heated to 150° C. under vacuum. After melting, the mold was cooled down to room temperature and the resulting composite part 530 was removed from the RTV mold. A photograph of the composite product 532 is shown in FIG. 5. The net density of the composite product 12 grams/cc.

A further exemplary embodiment of the present invention is that microstructures fabricated by the aforementioned methods can be attached to one another to produce a resulting structure with desirable features. For one example, two or more such grids or collimators can be stacked or combined together to yield a combined structure with greater size and/or a higher aspect ratio.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for making a high aspect ratio composite product, the method comprising:
providing a mold having a plurality of elevated patterns defining openings therein;
filling the mold with a molding composition comprising a powdered material and a binder;
hardening the binder to form a composite product in the mold; and
releasing the composite product from the mold.

2. The method as claimed in claim 1, further comprising lithographically patterning the mold by at least one of x-ray lithography and UV optical lithography.

3. The method as claimed in claim 1, wherein the mold comprises a molding product derived from the lithographic mold.

4. The method as claimed in claim 1, wherein the powder comprises at least one of metallic and ceramic material.

5. The method as claimed in claim 4, wherein the metallic powder comprises a high density metal

6. The method as claimed in claim 5, wherein the metal comprises at least one of tungsten, gold, tantalum, silver, copper, lead, and nickel, or a combinations thereof.

7. The method as claimed in claim 1, wherein the powders comprise particles of 0.1 to 100 micros in diameter.

8. The method as claimed in claim 1, wherein the binder comprises a thermally curable polymer.

9. The method as claimed in claim 8, wherein the thermally curable polymer comprises at least one of a vinyl, acrylic, and silicon-containing polymeric resin.

10. The method as claimed in claim 1, wherein the binder comprises a chemically curable polymer.

11. The method as claimed in claim 10, wherein the chemically curable polymer comprises an epoxy resin.

12. The method as claimed in claim 1, wherein the binder comprises a low-melt, fusible material.

13. The method as claimed in claim 12, wherein the low-melt, fusible material comprises at least one of lead, bismuth, tin, and indium, or mixtures thereof.

14. The method as claimed in claim 12, wherein the low-melt, fusible material comprises a wax.

15. The method as claimed in claim 1, wherein the molding composition further comprises a dispersing agent.

16. The method as claimed in claim 1, wherein the molding composition further comprises a fluxing agent.

17. The method as claimed in claim 1, wherein the filling of the mold comprises vacuum casting.

18. The method as claimed in claim 1, wherein the filling of the mold comprises pressure casting.

19. The method as claimed in claim 1, wherein the filling of the mold comprises centrifugal casting.

20. The method as claimed in claim 1, wherein the filling of the mold further comprises infiltration of a binder.

21. The method as claimed in claim 20, wherein the infiltration comprises application of pressure.

22. The method as claimed in claim 20, wherein the infiltration comprises providing a vacuum.

23. The method as claimed in claim 20, wherein the infiltration comprises centrifugation.

24. The method as claimed in claim 1, wherein the hardening of the binder comprises thermal curing of the polymeric binder.

25. The method as claimed in claim 1, wherein the hardening of the binder comprises chemical curing of the polymeric binder.

26. The method as claimed in claim 1, wherein the hardening of the binder comprises cooling of the low-melt, fusible polymeric binder.

27. The method as claimed in claim 1, wherein the releasing of the composite product comprises chemically dissolving the mold.

28. The method as claimed in claim 1, wherein the releasing of the composite product comprises thermally shrinking the mold.

29. The method as claimed in claim 1, wherein the releasing of the composite product comprises thermally burning the mold.

30. The method as claimed in claim 1, wherein the releasing of the composite product comprises mechanically peeling the composite product from the mold.

31. The method as claimed in claim 1, wherein the composite product comprises at least a portion of the mold materials remaining therein.

32. The method as claimed in claim 1, wherein the composite product comprise materials having a density from approximately 5 grams/cm³ to approximately 9 grams/cm³.

33. The method as claimed in claim 1, wherein the composite product comprises materials having a density from approximately 9 grams/cm³ to approximately 12 grams/cm³.

34. The method as claimed in claim 1, wherein the aspect ratio of the composite product is greater than approximately 2:1.

35. The method as claimed in claim 1, wherein the aspect ratio of the composite product is greater than approximately 4:1.

36. The method as claimed in claim 1, wherein the aspect ratio of the composite product is greater than approximately 8:1.

37. The method as claimed in claim 1, wherein the aspect ratio of the composite product is greater than approximately 16:1.

38. The method as claimed in claim 1, wherein the aspect ratio of the composite product is greater than approximately 32:1.

39. The method as claimed in claim 1, further comprising planarizing the composite product.

40. The method as claimed in claim 1, further comprises assembling a plurality of the composite products.

41. The method as claimed in claim 40, wherein an aspect ratio of the composite products is greater than approximately 100:1.

42. The method as claimed in claim 40, wherein the assembling comprises at least one of stacking of at least a portion of the plurality of the composite products and attaching at least a portion of the plurality of the composite products.

43. The method as claimed in claim 40, wherein the assembling comprises affecting at least one of a size and aspect ration of the composite product.

44. The method as claimed in claim 1, wherein the composite product comprises at least one of anti-scatter grids for x-ray imaging and collimators for nuclear imaging.

45. A method comprising:
providing a mold having a plurality of elevated patterns defining openings therein;
filling the mold with a molding composition having a powdered low-melt, fusible material mixed with a plurality of dense particles;
melting powdered low-melt, fusible material in the mold;
solidifying the molding composition in the mold; and
releasing a composite product from the mold.

46. The method as claimed in claim 45, wherein the dense particles comprise metal-coated powders.

47. The method as claimed in claim 46, wherein the metal-coated powders comprise at least one of tin-coated tungsten powder and copper-coated tungsten powder.

48. The method as claimed in claim 45, wherein the composite product comprises materials having a density from approximately 9 grams/cm³ to approximately 11 grams/cm³.

49. The method as claimed in claim 45, wherein the composite product comprises materials having a density from approximately 11 grams/cm³ to approximately 14 grams/cm³.

50. The method as claimed in claim 45, further comprising planarizing the composite product.

51. The method as claimed in claim 45, wherein the composite product comprises at least one of anti-scatter grids for x-ray imaging and collimators for nuclear imaging.

52. The method as claimed in claim 45, further comprises assembling a plurality of the composite products.

53. The method as claimed in claim 51, wherein an aspect ratio of the composite products is greater than approximately 100:1.

54. The method as claimed in claim 45, wherein the assembling comprises at least one of stacking of at least a portion of the plurality of the composite products and attaching at least a portion of the plurality of the composite products.

55. The method as claimed in claim 45, wherein the assembling comprises affecting at least one of a size and aspect ration of the composite product.
